(19) United States
(12) Patent Application Publication
(10) Pub. No.: US 2022/0267581 A1
(43) Pub. Date: Aug. 25, 2022

(54) THERMAL INSULATING SURFACE STRUCTURE OF CUSHION FOR AUTOMOBILE AND MOTORCYCLE

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); SHIH-HSUN YEN, TAIPEI (TW)

(21) Appl. No.: 17/383,441

(22) Filed: Jul. 23, 2021

(30) Foreign Application Priority Data
Feb. 24, 2021 (TW) 110106496

(51) Int. Cl. C08L 27/06; C08K 5/56; C08K 3/36; C08K 13/02; C08J 7/06; C08J 7/04; B60N 2/58; B62J 1/00; B32B 27/08; B32B 27/30; B32B 27/20

(52) U.S. Cl. CPC C08L 27/06; C08K 5/56; C08K 3/36; C08K 13/02; C08J 7/06; C08J 7/0423; B60N 2/58; B62J 1/00; B32B 27/08; B32B 27/304; B32B 27/20; C08J 2327/06; B32B 2270/00; B32B 2264/1056; B32B 2264/105; B32B 2307/304; B32B 2307/302; B32B 2307/416; B32B 2255/10; B32B 2255/20; B32B 2250/02; B32B 2250/24

(57) ABSTRACT

A thermal insulating surface structure of a cushion for automobiles and motorcycles is provided. The thermal insulating surface structure includes a main body layer. The main body layer is formed from a polyvinyl chloride resin composition. The polyvinyl chloride resin composition includes polyvinyl chloride and a metal complex. Based on a total weight of the polyvinyl chloride resin composition being 100 wt %, an amount of the metal complex ranges from 3 wt % to 20 wt %.

### CROSS-REFERENCE TO RELATED PATENT APPLICATION

This application claims the benefit of priority to Taiwan Patent Application No. 110106496, filed on Feb. 24, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a thermal insulating surface structure, and more particularly to a thermal insulating surface structure of a cushion for automobiles and motorcycles.

### BACKGROUND OF THE DISCLOSURE

Artificial leather is a common material of a cushion that is used for automobiles and motorcycles. Main materials of the artificial leather are made from polyvinyl chloride and carbon black. After adding a plasticizer, polyvinyl chloride can have elasticity and a soft texture, such that polyvinyl chloride can have more extensive applications. Carbon black is a common black pigment which can allow the artificial leather to have a dark color or a black color. However, carbon black is capable of absorbing heat, such that a surface temperature of the artificial leather remains high after being exposed to the sun for a period of time.

When a cushion for automobiles and motorcycles is directly exposed to the sun, especially during summer, a surface temperature of the artificial leather can reach up to a temperature ranging from 75° C. to 80° C. The high temperature of the artificial leather may cause discomfort to users or even burn the users.

Therefore, there is still room for improvement in the application of the conventional artificial leather in order to overcome the problems caused by the rising of temperature due to sun exposure.

### SUMMARY OF THE DISCLOSURE

In response to the above-referenced technical inadequacy, the present disclosure provides a thermal insulating surface structure of a cushion for automobiles and motorcycles.

In one aspect, the present disclosure provides a thermal insulating surface structure of a cushion for automobiles and motorcycles. The thermal insulating surface structure includes a main body layer formed from a polyvinyl chloride resin composition. The polyvinyl chloride resin composition includes polyvinyl chloride and a metal complex. Based on a total weight of the polyvinyl chloride resin composition being 100 wt %, an amount of the metal complex ranges from 3 wt % to 20 wt %.

In certain embodiments, a central atom of the metal complex is selected from the group consisting of manganese, iron, cobalt, and vanadium.

In certain embodiments, the polyvinyl chloride resin composition includes a porous material. Based on the total weight of the polyvinyl chloride resin composition being 100 wt %, an amount of the porous material ranges from 1 wt % to 10 wt %.

In certain embodiments, the porous material is selected from the group consisting of: an aerogel, a hollow foam bead, diatomite, and any combination thereof.

In certain embodiments, the thermal insulating surface structure includes a white reflection layer. The white reflection layer is disposed on one surface of the main body layer. The white reflection layer includes: titanium dioxide, barium sulfate, magnesium oxide, zinc sulfide, calcium fluoride, lithium fluoride, sodium fluoride, potassium fluoride, lithopone, magnesium carbonate, barium titanate, barium ferrite, or any combination thereof.

In certain embodiments, the polyvinyl chloride resin composition includes a first polyvinyl chloride resin composition and a second polyvinyl chloride resin composition. The main body layer includes a rubber layer and a cooling layer. The rubber layer is formed from the first polyvinyl chloride resin composition. The first polyvinyl chloride resin composition contains polyvinyl fluoride and the metal complex. The cooling layer is disposed on the rubber layer. The cooling layer is formed from the second polyvinyl chloride resin composition. The second polyvinyl chloride resin composition contains polyvinyl fluoride and a porous material.

In certain embodiments, the porous material is selected from the group consisting of: an aerogel, a hollow foam bead, diatomite, and any combination thereof.

In certain embodiments, the polyvinyl chloride resin composition includes a first polyvinyl chloride resin composition and a second polyvinyl chloride resin composition. The main body layer includes a rubber layer and a cooling layer. The rubber layer is formed from the first polyvinyl chloride resin composition. The first polyvinyl chloride resin composition contains polyvinyl fluoride and the metal complex. The cooling layer is disposed on the rubber layer. The cooling layer is formed from the second polyvinyl chloride resin composition. The second polyvinyl chloride resin composition contains polyvinyl fluoride and a thermal conductive material.

In certain embodiments, the thermal conductive material is selected from the group consisting of: graphite, alumina, magnesium oxide, zinc oxide, aluminum nitride, boron nitride, silicon carbide, and any combination thereof.

In certain embodiments, the thermal insulating surface structure further includes a white reflection layer. The white reflection layer is disposed between the rubber layer and the cooling layer. The white reflection layer includes titanium dioxide, barium sulfate, magnesium oxide, zinc sulfide, calcium fluoride, lithium fluoride, sodium fluoride, potassium fluoride, lithopone, magnesium carbonate, barium titanate, barium ferrite, or any combination thereof.

In certain embodiments, a ratio of a thickness of the cooling layer to a thickness of the rubber layer ranges from 0.5 to 2.

Therefore, by virtue of “the polyvinyl chloride resin composition including polyvinyl chloride and the metal complex” and “the amount of the metal complex ranging from 3 wt % to 20 wt % based on the total weight of the polyvinyl chloride resin composition being 100 wt %”, a thermal-insulating effect of the thermal insulating surface structure provided by the present disclosure can be enhanced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a cushion for a motorcycle;

FIG. 2 is a schematic side view of a thermal insulating surface structure according to a first embodiment of the present disclosure;

FIG. 3 is a schematic side view of the thermal insulating surface structure according to a second embodiment of the present disclosure;

FIG. 4 is a schematic side view of the thermal insulating surface structure according to a third embodiment of the present disclosure; and

FIG. 5 is a schematic side view of the thermal insulating surface structure according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

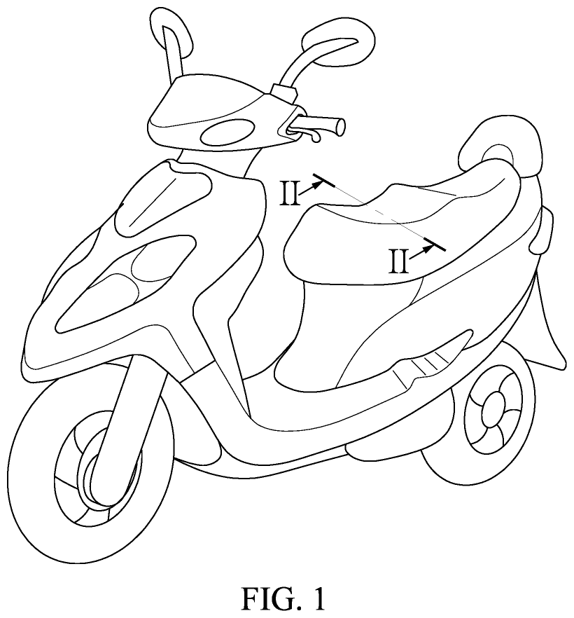

Referring to FIG. 1, the present disclosure provides a thermal insulating surface structure which can be applied to a cushion for automobiles and motorcycles. The thermal insulating surface structure can reflect a part of infrared light and a part of visible light. Therefore, even under sun exposure, a surface temperature of the thermal insulating surface structure provided by the present disclosure will not be higher than 55° C. Specifically, a total solar reflectance (TSR) of the thermal insulating surface structure can be lower than 40%, and an infrared light rejection (IR-cut) of the thermal insulating surface structure can be higher than 20%.

### First Embodiment

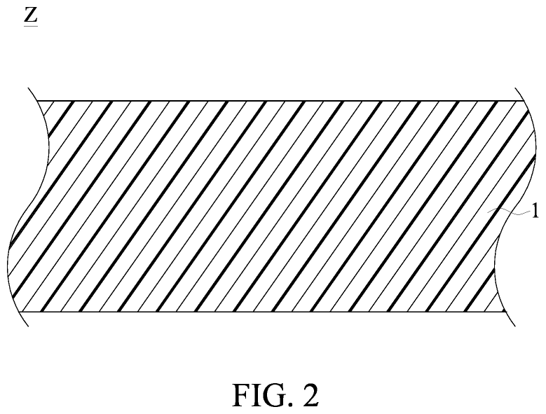

Referring to FIG. 2, a first embodiment of the present disclosure provides a thermal insulating surface structure Z. The thermal insulating surface structure Z includes a main body layer 1. The main body layer 1 is formed from a polyvinyl chloride resin composition. The polyvinyl chloride resin composition includes polyvinyl chloride and a metal complex.

In the present embodiment, the polyvinyl chloride resin composition is a resin composition with a main component of polyvinyl chloride. Based on a total weight of the polyvinyl chloride resin composition being 100 wt %, an amount of polyvinyl chloride ranges from 60 wt % to 90 wt %. A central atom of the metal complex is selected from the group consisting of manganese, iron, cobalt, and vanadium. For example, the metal complex can be produced by Ferro Corporation as the model F6331, produced by ISK Co., LTD as the models SG-103 and SG-101, or produced by Tomatec Co., Ltd as the models of 42-707A and 42-714A.

In addition, the polyvinyl chloride resin composition can include other resins, such as an acrylic resin, an alkyd resin, a polyester resin, a polyurethane resin, an epoxy resin, a phenolic resin, a melamine resin, an amino resin, a chlorinated vinyl resin, or any combination thereof.

The metal complex of the present disclosure also has effects of a dark pigment and a reflective filler. Specifically, the metal complex containing manganese, iron, cobalt, or vanadium enables the main body layer 1 to have a dark color or a black color. Accordingly, the thermal insulating surface structure Z of the present disclosure can have a similar color to an artificial leather of the cushions for automobiles and motorcycles on the market. Moreover, the metal complex can reflect a part of infrared light to prevent a surface temperature of the main body layer 1 from rising (75° C. to 80° C.) after a prolonged exposure to the sun.

In some embodiments, an amount of the added metal complex ranges from 3 wt % to 20 wt % based on the total weight of the polyvinyl chloride resin composition being 100 wt %. Therefore, the thermal insulating surface structure Z of the present disclosure can have a good infrared light reflective effect, and a cost of the thermal insulating surface structure Z can be reduced. When the amount of the metal complex added is higher than 20 wt %, the infrared light reflective effect of the thermal insulating surface structure Z can still be enhanced, however, the cost of the thermal insulating surface structure Z cannot be met due to the infrared light reflective effect approaching a critical value.

The polyvinyl chloride resin composition can further include a porous material. Gases are contained in an interior of the porous material. Generally, thermal conductivities of gases are lower than thermal conductivities of solids. Therefore, an addition of the porous material can achieve an effect of blocking heat transfer. For example, the porous material is selected from the group consisting of: aerogel, a hollow foam bead, diatomite, and any combination thereof, but is not limited thereto. A density of the main body layer 1 ranges from 0.5 g/cm³ to 1.2 g/cm³ after adding the porous material.

In some embodiments, an amount of the porous material ranges from 1 wt % to 10 wt % based on the total weight of the polyvinyl chloride resin composition being 100 wt %. Therefore, the thermal insulating surface structure Z can have a good thermal insulating effect. When the amount of the porous material is higher than 10 wt %, extensibility and structural strength of the thermal insulating surface structure Z can be negatively influenced.

In addition, the polyvinyl chloride resin composition can further include a thermal conductive material. An addition of the thermal conductive material can enhance a thermal conductivity of the polyvinyl chloride resin composition, so as to achieve an effect of transferring heat. For example, the thermal conductive material is selected from the group consisting of: graphite, alumina, magnesium oxide, zinc oxide, aluminum nitride, boron nitride, silicon carbide, and any combination thereof.

In some embodiments, an amount of the added thermal conductive material ranges from 1 wt % to 60 wt % based on the total weight of the polyvinyl chloride resin composition being 100 wt %. Therefore, the thermal insulating surface structure Z can have a good thermal conductivity. When the amount of the added thermal conductive material is higher than 60 wt %, the extensibility and the structural strength of the thermal insulating surface structure Z can be negatively influenced.

In some embodiments, the polyvinyl chloride resin composition is a foaming material, that is, the polyvinyl chloride resin composition can include a physical foaming agent or a chemical foaming agent to allow the main body layer 1 to be a foaming layer. Foaming agents (the physical foaming agent and/or the chemical foaming agent) and the porous material can be present in the polyvinyl chloride resin composition at the same time.

In the first embodiment, the total solar reflectance (TSR) of the thermal insulating surface structure Z is lower than 40%, and the infrared light rejection (IR-cut) of the thermal insulating surface structure Z is higher than 20%.

### Second Embodiment

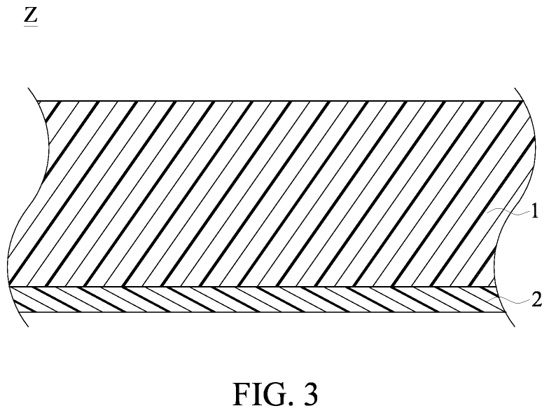

Referring to FIG. 3, a second embodiment of the present disclosure provides the thermal insulating surface structure Z. The thermal insulating surface structure Z of the second embodiment is similar to the thermal insulating surface structure Z of the first embodiment. The difference is that the thermal insulating surface structure Z of the second embodiment further includes a white reflection layer 2. The white reflection layer 2 is disposed on one surface of the main body layer 1.

In practice, the main body layer 1 has an exposed surface, and the white reflection layer 2 is disposed on a surface of the main body layer 1 opposite to the exposed surface. After a part of a light is absorbed by the metal complex, another part of the light passing through the main body layer 1 is reflected by the white reflection layer 2 to prevent heat storage.

The main body layer 1 is formed from the polyvinyl chloride resin composition. The polyvinyl chloride resin composition of the second embodiment is similar to that in the first embodiment. The polyvinyl chloride resin composition includes polyvinyl chloride and the metal complex, and can further include the aforesaid porous material and/or the aforesaid thermal conductive material, so it is not reiterated herein.

The white reflection layer 2 is formed by coating a reflective paste onto the main body layer 1. The reflective paste includes titanium dioxide, barium sulfate, magnesium oxide, zinc sulfide, calcium fluoride, lithium fluoride, sodium fluoride, potassium fluoride, lithopone, magnesium carbonate, barium titanate, barium ferrite, or any combination thereof.

The main body layer 1 has a dark color, thereby restricting a reflective effect to visible light. Accordingly, the white reflection layer 2 is disposed on the surface of the main body layer 1 opposite to the exposed surface, so as to enhance the heat reflective effect.

It should be noted that, when the thermal insulating surface structure Z includes the white reflection layer 2, the infrared light rejection of the thermal insulating surface structure Z can be apparently enhanced. In the second embodiment, the total solar reflectance (TSR) of the thermal insulating surface structure Z can be lower than 40%, and the infrared light rejection (IR-cut) of the thermal insulating surface structure Z can be higher than 20%.

### Third Embodiment

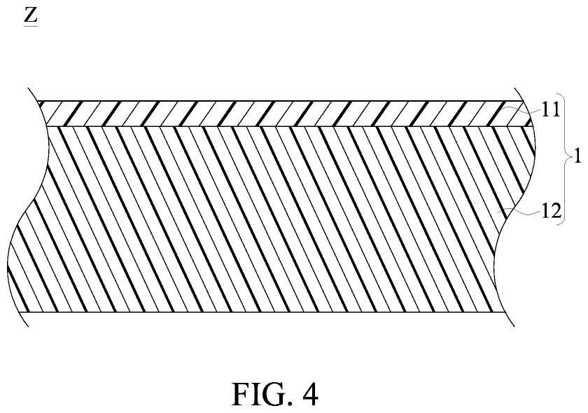

Referring to FIG. 4, a third embodiment of the present disclosure provides the thermal insulating surface structure Z. The thermal insulating surface structure Z includes the main body layer 1. The main body layer 1 includes a rubber layer 11 and a cooling layer 12 stacked with each other. In the third embodiment, a thickness of the rubber layer 11 ranges from 0.3 μm to 1 μm, and a thickness of the cooling layer 12 ranges from 0.3 μm to 1.5 μm. Preferably, a ratio of the thickness of the cooling layer 12 to the thickness of the rubber layer 11 ranges from 0.3 to 5. Much preferably, the ratio of the thickness of the cooling layer 12 to the thickness of the rubber layer 11 ranges from 0.5 to 2.

The rubber layer 11 is formed form a first polyvinyl chloride resin composition. The first polyvinyl chloride resin composition includes polyvinyl chloride and the metal complex. Based on a total weight of the first polyvinyl chloride resin composition being 100 wt %, the amount of polyvinyl chloride ranges from 60 wt % to 90 wt %, and the amount of the metal complex ranges from 3 wt % to 20 wt %. Specific kinds of the metal complex are similar to those previously described and is not reiterated herein. Therefore, the rubber layer 11 has a dark color or a black color, which enables the rubber layer 11 to absorb a part of infrared light.

In a preferable embodiment, the first polyvinyl chloride resin composition forming the rubber layer 11 is a foaming material, and the rubber layer 11 can be a foaming rubber layer.

In other embodiments, the first polyvinyl chloride resin composition can further include the aforesaid porous material and/or the aforesaid thermal conductive material, so that the rubber layer 11 can also have a thermal insulating effect. Specifically, the amount of the added porous material ranges from 1 wt % to 10 wt %, and the amount of the added thermal conductive material ranges from 1 wt % to 60 wt % based on the total weight of the first polyvinyl chloride resin composition being 100 wt %. A density of the rubber layer 11 ranges from 0.5 g/cm³ to 1.2 g/cm³.

The cooling layer 12 is formed from a second polyvinyl chloride resin composition. The second polyvinyl chloride resin composition includes polyvinyl chloride and the porous material and/or the thermal conductive material. Based on a total weight of the second polyvinyl chloride resin composition being 100 wt %, the amount of polyvinyl chloride ranges from 60 wt % to 90 wt %, the amount of the porous material ranges from 1 wt % to 10 wt %, and the amount of the thermal conductive material ranges from 1 wt % to 60 wt %. Specific kinds of the porous material and the thermal conductive material are similar to those previously described and will not be reiterated herein.

Due to the addition of the porous material, the cooling layer 12 can contain more gases, so that a thermal conductivity of the cooling layer 12 can be decreased to have a good thermal conductive effect. In addition, the gases contained in the cooling layer 12 can promote heat convention to transfer heat energy so as to cool down the temperature of the cooling layer 12. The addition of the thermal conductive material can enhance the thermal conductive effect of the cooling layer 12.

The second polyvinyl chloride resin composition forming the cooling layer 12 can also be a foaming material, so that the cooling layer 12 can be a foaming cooling layer to increase an amount of the gases contained in the cooling layer 12. Specifically, a density of the cooling layer 12 ranges from 0.4 g/cm³ to 0.8 g/cm³, and the density of the cooling layer 12 is lower than the density of the rubber layer 11.

The method for disposing the cooling layer 12 onto the rubber layer 11 is not limited to the following examples. For example, the first polyvinyl chloride resin composition and the second polyvinyl chloride resin composition are co-extruded from the rubber layer 11 and the cooling layer 12 that are stacked with each other. In one method, after one of the rubber layer 11 and the cooling layer 12 is formed, the other one of the rubber layer 11 and the cooling layer 12 is formed thereon by coating. In another method, the rubber layer 11 and the cooling layer 12 are respectively formed, and then the rubber layer 11 and the cooling layer 12 are connected with each other though heat compression. In another method, the rubber layer 11 and the cooling layer 12 are respectively formed, and then an adhesive layer is disposed between the rubber layer 11 and the cooling layer 12.

In the third embodiment, the total solar reflectance (TSR) of the thermal insulating surface structure Z can be lower than 40%, and the infrared light rejection (IR-cut) of the thermal insulating surface structure Z can be higher than 20%.

### Fourth Embodiment

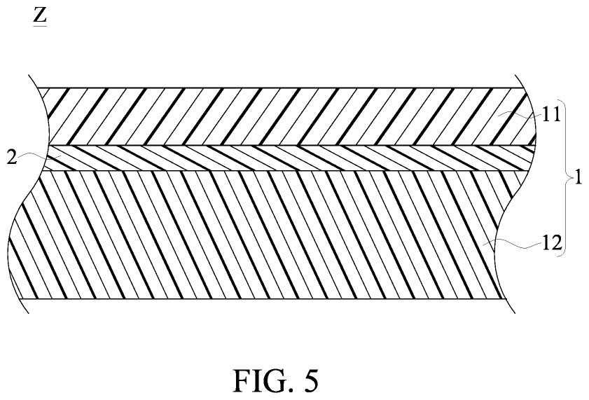

Referring to FIG. 5, a fourth embodiment of the present disclosure provides the thermal insulating surface structure Z. The thermal insulating surface structure Z of the fourth embodiment is similar to the thermal insulating surface structure Z of the third embodiment. The difference is that the thermal insulating surface structure Z further includes a white reflection layer 2. The white reflection layer 2 is disposed between the rubber layer 11 and the cooling layer 12.

The rubber layer 11 is formed from the first polyvinyl chloride resin composition. The first polyvinyl chloride resin composition of the fourth embodiment is similar to the first polyvinyl chloride resin composition of the third embodiment. Therefore, the rubber layer 11 can absorb a part of infrared light, and the rubber layer 11 has a dark color or a black color.

The cooling layer 12 is formed from the second polyvinyl chloride resin composition. The second polyvinyl chloride resin composition of the fourth embodiment is similar to the second polyvinyl chloride resin composition of the third embodiment. Therefore, the cooling layer 12 can achieve an effect of blocking heat transfer.

In the fourth embodiment, the thermal insulating surface structure Z has three kinds of thermal insulating mechanisms. The metal complex of the rubber layer 11 can absorb a part of infrared light. The porous material and/or the thermal conductive material of the rubber layer 11 and/or the cooling layer 12 can block heat transfer. The white reflection layer 2 can reflect visible light and infrared light. Accordingly, even after a prolonged exposure to the sun, the surface temperature of the thermal insulating surface structure Z can still be maintained at a temperature lower than 55° C.

It should be noted that, when the thermal insulating surface structure Z includes the rubber layer 11 that is black and the white reflection layer 2, the infrared light rejection of the thermal insulating surface structure Z is apparently enhanced. In the fourth embodiment, the total solar reflectance (TSR) of the thermal insulating surface structure Z can be lower than 40%, and the infrared light rejection of the thermal insulating surface structure Z can be higher than 20%.

### Beneficial Effects of the Embodiments

In conclusion, by virtue of “the polyvinyl chloride resin composition including polyvinyl chloride and a metal complex” and “the amount of the metal complex ranging from 3 wt % to 20 wt % based on the total weight of the polyvinyl chloride resin composition being 100 wt %”, the thermal insulating effect of the thermal insulating surface structure Z provided by the present disclosure can be enhanced.

Further, by virtue of “the polyvinyl chloride resin composition including the porous material”, the thermal insulating effect of the thermal insulating surface structure Z provided by the present disclosure can be enhanced.

Further, by virtue of “the thermal insulating surface structure Z including the white reflection layer 2”, the infrared light reflective effect of the thermal insulating surface structure Z provided by the present disclosure can be enhanced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A thermal insulating surface structure of a cushion for automobiles and motorcycles, comprising:
a main body layer formed from a polyvinyl chloride resin composition, wherein the polyvinyl chloride resin composition includes polyvinyl chloride and a metal complex, and an amount of the metal complex ranges from 3 wt % to 20 wt % based on a total weight of the polyvinyl chloride resin composition being 100 wt %.

2. The thermal insulating surface structure according to claim 1, wherein a central atom of the metal complex is selected from the group consisting of manganese, iron, cobalt, and vanadium.

3. The thermal insulating surface structure according to claim 1, wherein the polyvinyl chloride resin composition includes a porous material, and an amount of the porous material ranges from 1 wt % to 10 wt % based on the total weight of the polyvinyl chloride resin composition being 100 wt %.

4. The thermal insulating surface structure according to claim 3, wherein the porous material is selected from the group consisting of: an aerogel, a hollow foam bead, diatomite, and any combination thereof.

5. The thermal insulating surface structure according to claim 1, further comprising a white reflection layer disposed on one surface of the main body layer, wherein the white reflection layer includes: titanium dioxide, barium sulfate, magnesium oxide, zinc sulfide, calcium fluoride, lithium fluoride, sodium fluoride, potassium fluoride, lithopone, magnesium carbonate, barium titanate, barium ferrite, or any combination thereof.

6. The thermal insulating surface structure according to claim 1, wherein the polyvinyl chloride resin composition includes a first polyvinyl chloride resin composition and a second polyvinyl chloride resin composition, and the main body layer includes:
a rubber layer formed from the first polyvinyl chloride resin composition, and the first polyvinyl chloride resin composition containing polyvinyl fluoride and the metal complex; and
a cooling layer disposed on the rubber layer, the cooling layer being formed from the second polyvinyl chloride resin composition, and the second polyvinyl chloride resin composition containing polyvinyl fluoride and a porous material.

7. The thermal insulating surface structure according to claim 6, wherein the porous material is selected from the group consisting of: an aerogel, a hollow foam bead, diatomite, and any combination thereof.

8. The thermal insulating surface structure according to claim 1, wherein the polyvinyl chloride resin composition includes a first polyvinyl chloride resin composition and a second polyvinyl chloride resin composition, and the main body layer includes:
a rubber layer formed from the first polyvinyl chloride resin composition, and the first polyvinyl chloride resin composition containing polyvinyl fluoride and the metal complex; and
a cooling layer disposed on the rubber layer, the cooling layer being formed from the second polyvinyl chloride resin composition, and the second polyvinyl chloride resin composition containing polyvinyl fluoride and a thermal conductive material.

9. The thermal insulating surface structure according to claim 8, wherein the thermal conductive material is selected from the group consisting of: graphite, alumina, magnesium oxide, zinc oxide, aluminum nitride, boron nitride, silicon carbide, and any combination thereof.

10. The thermal insulating surface structure according to claim 6, further comprising a white reflection layer disposed between the rubber layer and the cooling layer, and the white reflection layer containing titanium dioxide, barium sulfate, magnesium oxide, zinc sulfide, calcium fluoride, lithium fluoride, sodium fluoride, potassium fluoride, lithopone, magnesium carbonate, barium titanate, barium ferrite, or any combination thereof.

11. The thermal insulating surface structure according to claim 6, wherein a ratio of a thickness of the cooling layer to a thickness of the rubber layer ranges from 0.5 to 2.
